(19) United States
(12) Patent Application Publication
(10) Pub. No.: US 2022/0335331 A1
(43) Pub. Date: Oct. 20, 2022

(54) METHOD AND SYSTEM FOR BEHAVIOR VECTORIZATION OF INFORMATION DE-IDENTIFICATION

(71) Applicant: Awoo Intelligence, Inc., Taipei City (TW)

(72) Inventors: Kuo-Ming LIN, Taipei City (TW); Chen-Wei LEE, Taipei City (TW); Szu-Wu LIN, Taipei City (TW)

(21) Appl. No.: 17/364,434

(22) Filed: Jun. 30, 2021

(30) Foreign Application Priority Data
Apr. 14, 2021 (TW) 110113471

(51) Int. Cl. G06N 20/00; G06N 5/00; G06K 9/62

(52) U.S. Cl. CPC G06N 20/00; G06N 5/003; G06K 9/6267

(57) ABSTRACT

A method for behavior vectorization of information de-identification, through which data concerning browsing traces, link paths, trigger events, clicks, and operation behaviors of network users on the Internet are selected by a server, a client device, or an edge device for performing a conversion/integration process. Then, the integrated data are converted into a vector. The vector represents the profile of the usage behavior of the network users. Moreover, because vectors can be quickly grouped and classified to find similar groups, it can quickly identify the network users. The server uses the supervised learning method as the base method, and uses pre-defined network behaviors for training. Also, the semi-supervised learning method or the unsupervised learning method can be employed to modify undefined network behaviors to better conform to the profile description of the network users.

### BACKGROUND OF INVENTION

### (1) Field of the Present Disclosure

The present disclosure relates to a method and a system for behavior vectorization of information de-identification, and more particularly to a method for representing the network user and in a de-identified and vectorized form, so as to vectorize and group the behavior of the network user.

### (2) Brief Description of Related Art

With the emergence of the Internet information age, user data can be obtained from multiple sources. It is no longer necessary to spend a lot of effort to search for available resources as in the past. However, such a convenient search mode also brings many problems, such as the problem with the protection of personal information, especially personally identifiable information. For example, the user's name, phone number, email, home address, etc., can easily flow to the Internet due to careless use or wrong operation and can be illegally used by those who are interested therein. Therefore, many network users refuse to disclose their personal information and basic details in order to protect themselves. However, for the advertising companies and online marketers, if the personal information or the basic data of the network users cannot be obtained, the efficiency of their marketing will be significantly reduced. As a result, accurate advertisement placement rates will be dropped such that sales to similar customer groups cannot be accurately performed. Therefore, how to analyze network users and to perform follow-up operations on the analyzed network user information without the violation of the protection of personal information has become a technical threshold that must be crossed. It is disclosed in TWI611362B (Title: “Personalized internet marketing recommendation method”) that the process that the user has experienced can be employed for analysis. Meanwhile, the similar groups can be found through quick grouping. Moreover, it is disclosed in CN109583920A (Title: “Method and management system for generating personalized consumption information”) that a quick grouping can be achieved by use of the process that the user has experienced. Accordingly, the similar groups can be searched based thereon. Also, it is possible to use machine learning methods such as deep learning to improve the system. Other disclosures of the prior art are provided as follows:

(1) TW202020771A “System and method for analyzing the network user behavior and presenting the result thereof”

(2) TW202025039A “Smart marketing advertising classification system”

(3) US20200160388A1 “Cryptographic anonymization for Zero-Knowledge Advertising Methods, Apparatus, and System”

(4) US20140122493A1 “Ecosystem method of aggregation and search and related techniques”

(5) JPA 2019219764 “Information Search System”

(6) JPA 2020184198 “Information processing equipment and information processing program”

According to the above-mentioned prior art, in order to solve the problem of personal information, marketers or online user behavior analysts start to collect users' browsing paths on the Internet and websites, analyze their browsing paths and then classify and group them, and finally employ the results of the classification and grouping for the purpose of advertising, marketing, etc. However, network users use multiple paths. Meanwhile, slightly different website stay time, click behaviors, operations, trigger events, etc., may change the analysis results. Furthermore, as for the use of machine learning for path learning analysis, it is likely to happen that the analysis results are distorted and useless once the path is not defined. How to make the path more clearly to represent the network user or even to describe the network user by the path, is a problem to be solved.

### SUMMARY OF INVENTION

It is a primary object of the present disclosure to provide a method and a system for behavior vectorization of information de-identification that can de-identify information and convert the path of network users in a vectorized form for grouping purpose.

According to the present disclosure, a server retrieves the data that is not personal information, such as the browsing traces, paths, the course, the trigger event, and the click operation of the network users on the Internet. The large amount of data is stacked, integrated, and then converted into a vector matrix. The vector matrix is employed to represent the profile, characteristics, identification code, consumption characteristics of the network users, etc., which can represent the data of the network users. The server can quickly group and classify the vector matrix, and then find similar groups to quickly identify network users. In addition, vector conversion, grouping and classification are defined and classified by the data provider, which pre-defines and classifies the network usage paths of past network users. The server is trained with machine learning based on the supervised learning method. After the machine learning is completed, the retrieved data can be stacked and vectorized. Meanwhile, the vector matrix can be classified after vectorization. The aforementioned vectorization can also be performed on the client side, such as: browsers, web pages, mobile devices, wearable devices, car appliances, Internet of Things, POS, etc., or Edge Server, or any combination of conversion calculations and aggregation so that the server can save costs and perform subsequent quick classification. The server employs the supervised learning method as a base method, and uses pre-defined network behaviors for training. Meanwhile, semi-supervised or unsupervised learning can also be employed as another base method. The degree of correlation can be inferred through continuous behavior for training. Also, semi-supervised learning method or unsupervised learning method can be used to provide feedback to the operations and the use of the network users with respect to the undefined network behaviors, so that the model can be re-learned and modified to better conform to the profile description of network users.

### BRIEF DESCRIPTION OF THE DRAWINGS

FIG. 1 is a schematic drawing of the composition of the present disclosure;

FIG. 2 is a flow chart of the present disclosure;

FIG. 3 is a schematic drawing I of the implementation of the present disclosure;

FIG. 4 is a schematic drawing II of the implementation of the present disclosure;

FIG. 5 is a schematic drawing III of the implementation of the present disclosure;

FIG. 6 is a schematic drawing IV of the implementation of the present disclosure;

FIG. 7 is a schematic drawing V of the implementation of the present disclosure;

FIG. 8 is a schematic drawing VI of the implementation of the present disclosure;

FIG. 9 is a schematic drawing VII of the implementation of the present disclosure;

FIG. 10 is a schematic drawing of another embodiment of the present disclosure; and

FIG. 11 is a schematic drawing of a further embodiment of the present disclosure.

### DETAILED DESCRIPTION OF PREFERRED EMBODIMENTS

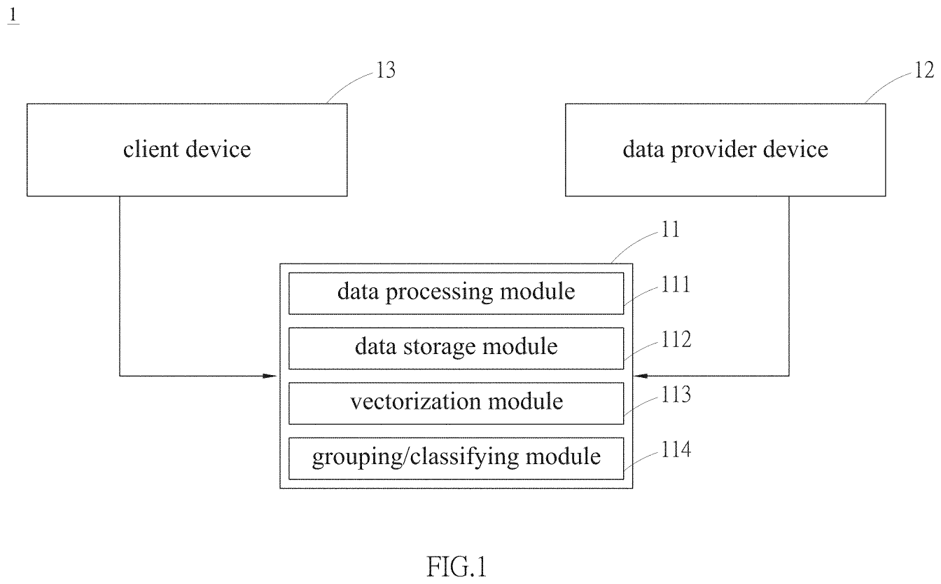

Referring to FIG. 1, a system 1 for behavior vectorization of information de-identification according to the present disclosure includes a server 11, a data provider device 12, and a client device 13.

The server 11 establishes an information link with the data provider device 12 and the client device 13. The server 11 can receive a learning training sample provided by the data provider device 12 and build a machine learning model based on the learning training sample provided by the data provider device 12. The model can mainly retrieve network usage paths of the client device 13 for stacking and vectorization, and then group and classify the vectorized data.

The data provider device 12 can be a search engine database or a data database. Any device that enables the server 11 to obtain the required learning and training samples can be employed.

The client device 13 can be one of a mobile phone, a tablet computer, a personal computer, etc. Any device that enables the server 11 to obtain the required samples to be tested, can be employed.

The client device 13 is operated by a client. The client can use the Internet through the client device 13, and the server 11 can retrieve the Internet path used by the client device 13. The client of the client device 13 mainly refers to a network user, but it is not limited thereto.

The server 11 mainly includes a data processing module 111, a data storage module 112, a vectorization module 113, and a grouping/classifying module 114 which establish an information link with each other. The data processing module 111 is used to run the server 11 and to drive the modules connected thereto. The data processing module 111 fulfills functions such as logic operations, temporary storage of operation results, and storage of execution instruction positions. It can be, for example, a CPU, but is not limited thereto.

The data storage module 112 can store electronic data, which can be, for example, a Solid State Disk or Solid State Drive (SSD), a Hard Disk Drive (HDD), a Static Random Access Memory (SRAM), or a Random Access Memory (DRAM), etc. The data storage module 112 mainly stores path vector learning data and vector grouping learning data transmitted by the data provider device 12, path data transmitted by the client device 13, and data calculated and processed by the server 11.

The vectorization module 113 mainly performs training and learning for the path vector learning data provided by the data provider device 12. After the training and learning are completed, the vectorization module 113 can convert the path data transmitted by the client device 13 into vectorized data. The training and learning of the vectorization module 113 mainly use machine learning such as supervised learning, semi-supervised learning, reinforcement learning, unsupervised learning, self-supervised learning or heuristic algorithms, but not limited thereto. The above-mentioned path vector learning data can be a plurality of past path data and a plurality of past vectorized data. The past path data and the path data can be any data of a website trigger event, a website click event, a website operation behavior, a website stay time, or a combination thereof. Any data referring to the visiting traces on the Internet is applicable. The past vectorized data mainly correspond to the past path data, and are used for training and learning by the vectorization module 113. The vectorized data can be one of two-dimensional matrix vector, three-dimensional matrix vector, or multi-dimensional matrix vector. The vectorization module 113 mainly stacks and converts each one-dimensional data in the path data into the vectorized data. For example, a network user of the client device 13 stays on a website A for 5 minutes and 30 seconds, clicks on three products, and each is linked to other external websites corresponding to the three products, then returns back to the website A. Meanwhile, the network user watches advertisements A, B, C on the website A for 15 seconds, respectively. In this case, a matrix of the client device 13 can be provided by the vectorization module 113 and defined to be: [0.33, 3, 0.45] ([total stay time, number of products clicked, total time to watch advertisements]). The above-mentioned case is only an example, but should not limited thereto. After the vectorization module 113 converts the path data into the vectorized data, it can be stored in the data storage module 112 or transmitted to the subsequent grouping/classifying module 114.

The grouping/classifying module 114 can perform training and learning for the vector grouping learning data provided by the data provider device 12. After the training and learning are completed, the grouping/classifying module 114 can assign a grouping result to the vectorized data transmitted by the vectorization module 113. The grouping/classifying module 114 can group and classify the vectorized data transmitted by the vectorization module 113. The training and learning of the grouping/classifying module 114 mainly uses machine learning such as supervised learning, semi-supervised learning, reinforcement learning, unsupervised learning, self-supervised learning or heuristic algorithms, but not limited thereto. The vector grouping learning data include mainly a plurality of the past vectorized data and a past grouping data. The past grouping data can include a plurality of the past vectorized data of the aforementioned past network users for training and learning by the grouping/classifying module 114. Moreover, the grouping result can be a group or set containing a plurality of vectorized data representing network users.

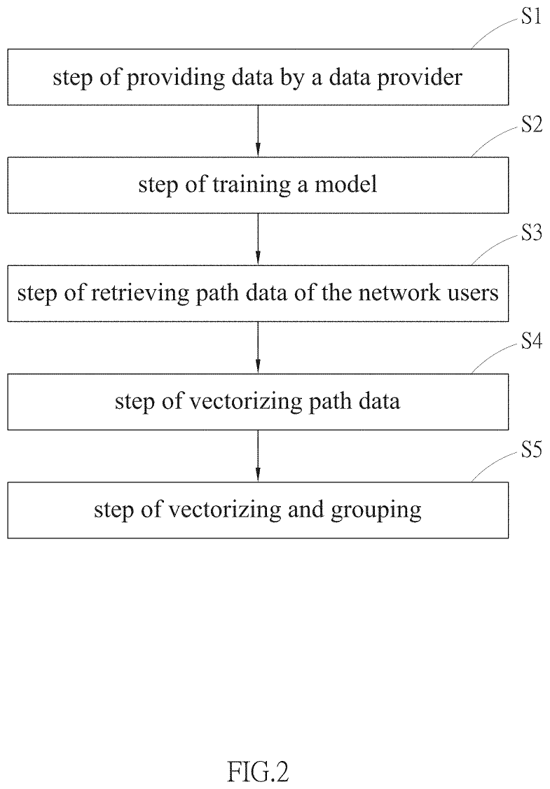

As illustrated in FIG. 2 together with FIG. 1, steps of the present disclosure are shown as follows:

(1) Step S1 of providing data by a data provider:

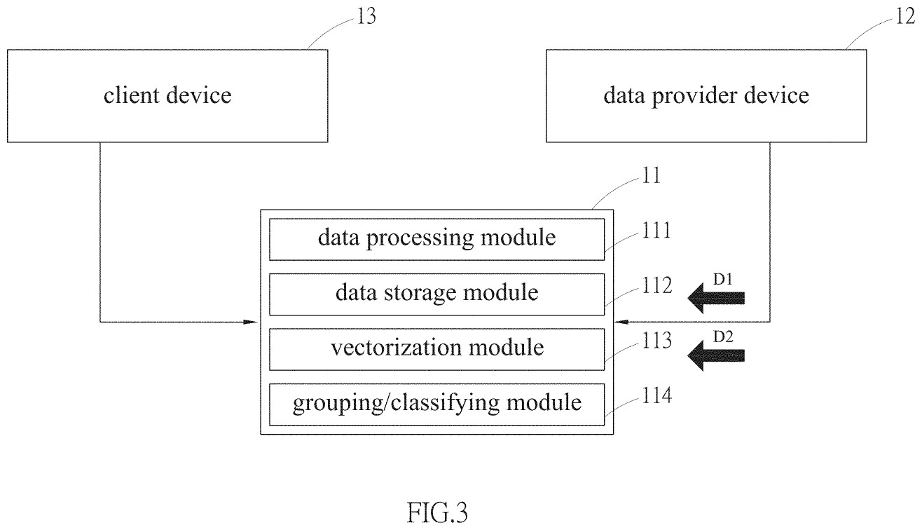

As shown in FIG. 3, the server 11 receives a path vector learning data D1 and a vector grouping learning data D2 transmitted by a data provider device 12. The data processing module 111 respectively transmits the path vector learning data D1 to the vectorization module 113, and the vector grouping learning data D2 to the grouping/classifying module 114 for training and learning. The above-mentioned path vector learning data D1 can be a plurality of past path data and a plurality of past vectorized data. The past path data can be any data of a website trigger event, a website click event, a website operation behavior, a website stay time, or a combination thereof. Any data referring to the visiting traces left on the Internet is applicable. The vector grouping learning data D2 can include a plurality of the past vectorized data and a plurality of past grouping data. The past grouping data can include a plurality of the past vectorized data of the past network users, but not limited thereto.

(2) Step S2 of training a model:

After the vectorization module 113 receives the path vector learning data D1 transmitted by the data provider device 12 and the vector grouping learning data D2 of the grouping/classifying module 114, the vectorization module 113 uses the path vector learning data D1 as the past data to perform a first machine learning. The grouping/classifying module 114 uses the vector grouping learning data D2 as the past data to perform a second machine learning. The first and the second machine learning mainly refer to the machine learning such as supervised learning, semi-supervised learning, reinforcement learning, unsupervised learning, self-supervised learning or heuristic algorithms, but not limited thereto.

(3) Step S3 of retrieving path data of the network users:

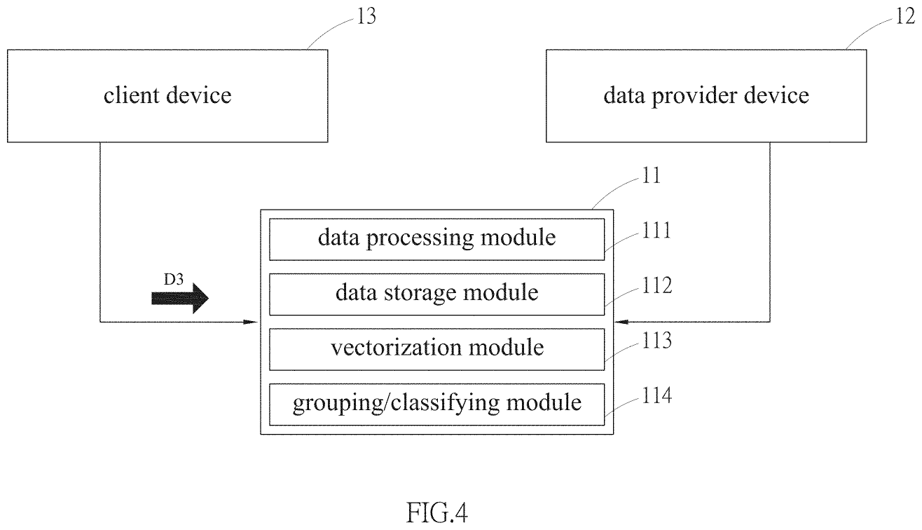

Following the above-mentioned steps and referring to FIG. 4, after the aforementioned first machine learning and the aforementioned second machine are completed, the data processing module 111 can retrieve a path data D3 of the client device 13. Meanwhile, the path data D3 are transmitted to the vectorization module 113 for subsequent operations. The past path data can be any data of a website trigger event, a website click event, a website operation behavior, a website stay time, or a combination thereof. Any data referring to the visiting traces left on the Internet by the client device 13 is applicable. For example: An network user of the client device 13 stays on website A for 10 minutes and 23 seconds, and clicks on 5 products, and each is linked to other external websites corresponding to the five products, then returns back to the website A. Meanwhile, the network user watches advertisements A, B, C on the website A for 20 seconds, respectively. Finally, after 2 products are searched and the website A is closed, the server 11 retrieves the time spent on the client device 13, the number of product clicks, the number of ads viewed, the time spent for watching ads, and the number of product searches, etc. But the data retrieved does not include the personal data stored in the client device 13. Finally, the server 11 then transmits the retrieved data to the vectorization module 113. The above-mentioned is only an example, and should not be limited thereto.

(4) Step S4 of vectorizing path data:

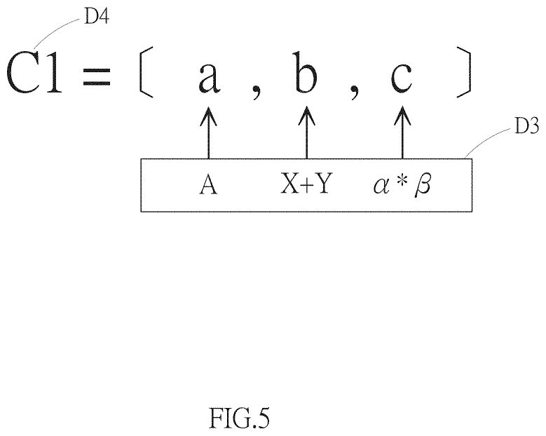

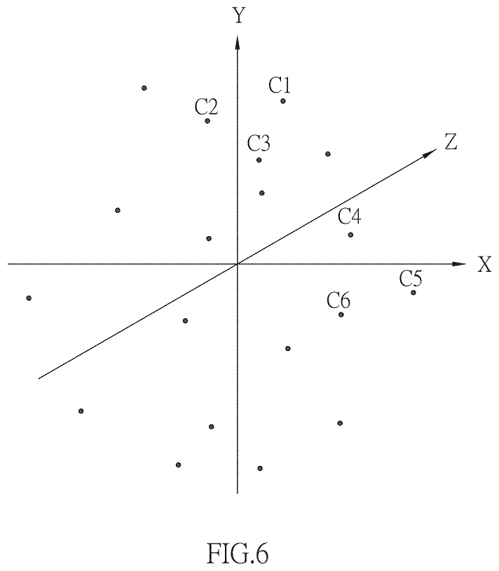

Referring to FIG. 5 and FIG. 6, after the vectorization module 113 receives the path data D3, it performs a data vectorization operation based on a result of the first machine learning to convert the path data D3 into a vectorized data D4. The data vectorization operation mainly converts one-dimensional data into one of two-dimensional vector matrix, three-dimensional vector matrix, or multi-dimensional vector matrix. For example: Continuing the example of step S3 of retrieving path data of the network user, the vectorization module 113 converts the 10 minutes and 23 seconds (total 623 seconds represented by A), that the network user of the client device 13 stays on the website A, to a part a of the vector matrix C1. Meanwhile, the part a is set to be 0.623. A part b of the vector matrix C1 is the number X of product clicks plus the number Y of product searches, and is set to be 7. A part c of the vector matrix C1 is the product of the number a of ads viewed and the time β spent for watching ads, and is set to be 0.6. After the vector matrix C1 is created, the three-dimensional spatial distribution thereof is illustrated in FIG. 6. C1 to C6 in FIG. 6 can all represent different network users of the client device. The above-mentioned conversion process is only an example. In actual operation, the path data D3 is converted into the vectorized data C1 based on the results of machine learning. The conversion illustrated here is not provided for limitation. The vectorization module 113 finally stores the generated vectorized data D4 to the data storage module 112, or transmits it to the subsequent grouping/classifying module 114.

(5) Step S5 of vectorizing and grouping:

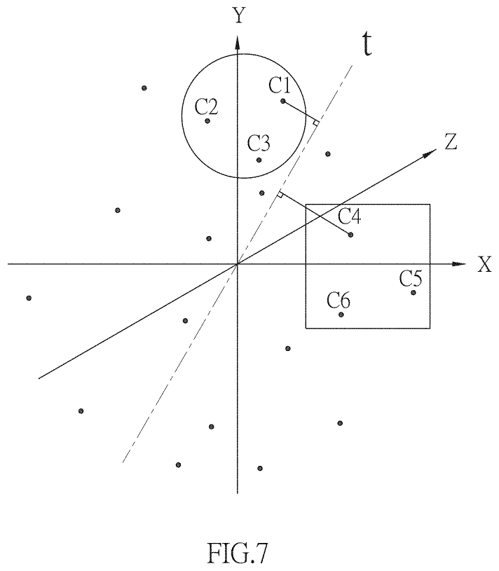

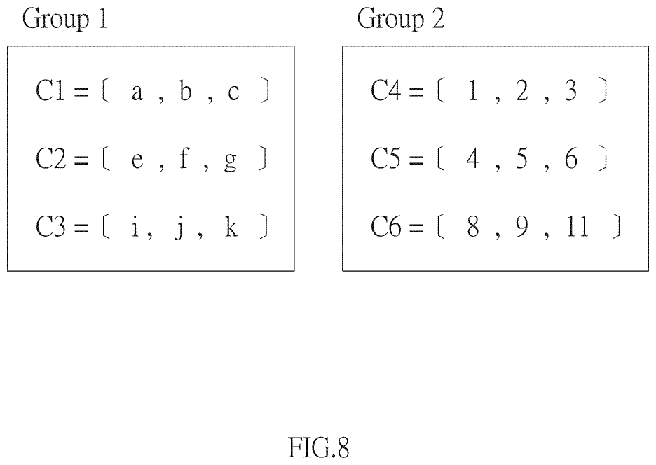

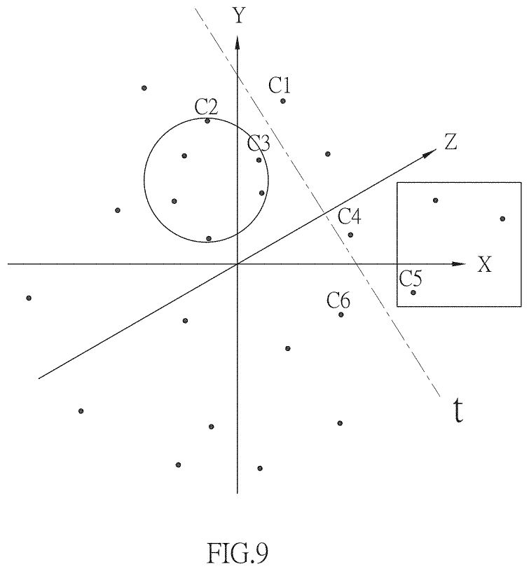

Following the above-mentioned steps and referring to FIG. 7 through FIG. 9, after receiving the vectorized data D4, the group classification module 114 performs a grouping action based on a result of the second machine learning. Meanwhile, a grouping result is assigned to the vectorized data D4. The grouping result is a group or a set that can contain a plurality of the vectorized data C1 representing the network user. For example: Continuing the example of the step S4 of vectorizing path data, a tangent t can represent that the grouping/classifying module 114 divides C1 to C6 into two groups under a certain grouping training topic. C1 to C3 can belong to group 1, and C4 to C6 can belong to group 2. Since C1 to C6 are all in the form of vectors, they can be classified quickly. In the same situation, the tangent line t is different in slope and direction due to different training topics, which makes the grouping results different. The above-mentioned grouping process is just an example. In actual operation, the result of machine learning is used to assign the grouping result of the vectorized data, and the conversion as illustrated here does not serve as a limitation. Finally, the grouping/classifying module 114 can store the grouping result to the data storage module 112.

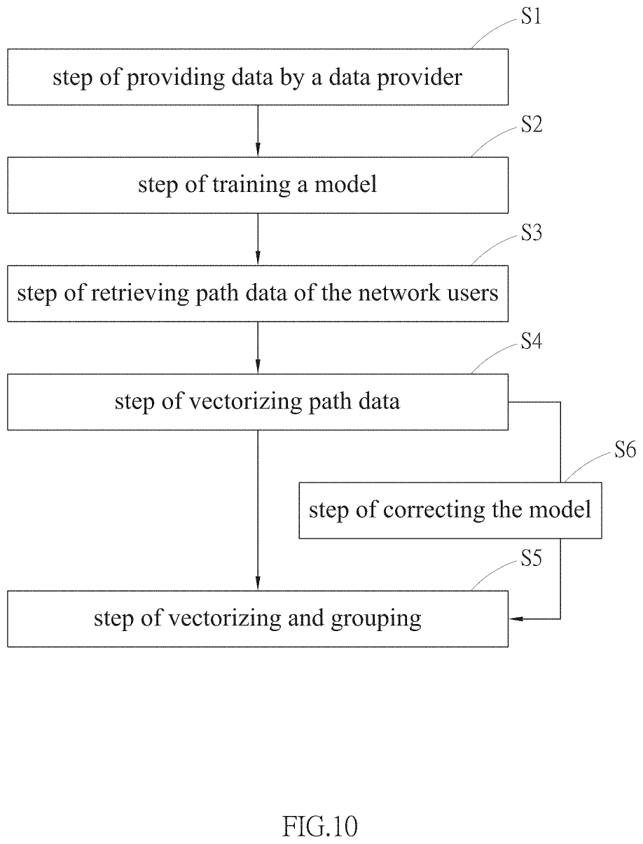

Referring to FIG. 10, the step S4 of vectorizing path data can be followed by a step S6 of correcting the model. After receiving the path data D3, the vectorization module 113 performs a data vectorization operation based on the result of the first machine learning. However, if the path data D3 transmitted by the client device 13 is data that has never appeared or rarely appeared in the past path data, the vectorization module 113 can modify the result of the first machine learning based on the path data. In this way, the subsequent vectorized data D4 is more consistent with the client device 13.

In the step S3 of retrieving path data of the network users and in the step S4 of vectorizing path data, the server 11 may further transmit the result of the first machine learning to the client device 13. After receiving the result of the first machine learning, the client device 13 can retrieve the path data D3 of the client device 13 in real time. Meanwhile, the path data D3 are converted into vectorized data D4, and then the vectorized data D4 are transmitted to the server 11.

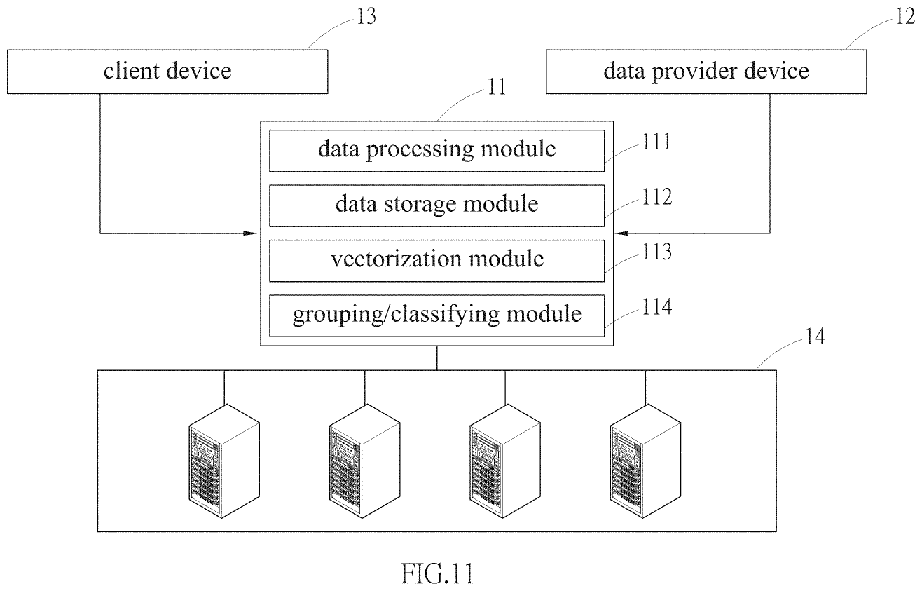

Referring to FIG. 11, the server 11 can establish an information link with at least one edge server 14. The edge server 14 mainly provides one of the edge computing functions of the server 11. The edge server 14 can be a mobile phone, a tablet computer, a personal computer, a central processing computer, etc. Any device that can share the computing functions of the server 11 is applicable. Edge computing is configured to decompose the large data that was originally processed by the central node and cut it into smaller and easier-to-manage data, and distribute it to the edge nodes for processing. Because the edge node is closer to the client device 13, the data processing and transmission speed can be accelerated, and the delay can be reduced.

In summary, the present disclosure is mainly based on machine learning. Without the need to obtain the personal information of the network user, the path of the network users on the Internet is vectorized and grouped. Meanwhile, the network users are identified according to the grouping results for facilitating the subsequent processing and use. The present invention can indeed provide a behavior vectorization method that de-identifies information, converts the path of network users in a vectorized way, and then de-identifies grouped information.

### REFERENCE SIGN

1 system for behavior vectorization of information de-identification
11 server
12 data provider device
111 data processing module
112 data storage module
113 vectorization module
114 grouping/classifying module
13 client device
14 edge server
D1 path vector learning data
D2 vector grouping learning data
D3 path data
D4 vectorized data
S1 step of providing data by a data provider
S2 step of training a model
S3 step of retrieving path data of the network users
S4 step of vectorizing path data
S5 step of vectorizing and grouping
S6 step of correcting the model

What is claimed is:

1. A method for behavior vectorization of information de-identification, comprising following steps:
providing data by a data provider, wherein a server is connected with a data provider device, and wherein the data provider device provides and transmits a path vector learning data and a vector grouping learning data to the server;
training a model, wherein, after the server receives the path vector learning data and the vector grouping learning data, a vectorization module of the server uses the path vector learning data as past data for performing a first machine learning, and wherein a grouping/classifying module of the server uses the vector grouping learning data as past data for performing a second machine learning;
retrieving path data of network users, wherein, after the first machine learning and the second machine learning are completed, the server retrieves a path data of a client device and transmits the path data to the vectorization module;
vectorizing path data, wherein the vectorization module performs a data vectorization action on the path data based on a result of the first machine learning such that the path data are converted into vectorized data, and wherein the vectorization module transmits the vectorized data to the grouping/classifying module; and
vectorizing and grouping, wherein the grouping/classifying module performs a grouping action on the vectorized data based on a result of the second machine learning, and assigns a grouping result to the vectorized data, and finally stores the grouping result to the server.

2. The method as claimed in claim 1, wherein the path vector learning data include a plurality of past path data and a plurality of past vectorized data, and wherein the past vectorized data are one of a website trigger event, a website click event, a website operation behavior, a website stay time of the past path data, or a combination thereof.

3. The method as claimed in claim 2, wherein the vector grouping learning data include a plurality of the past vectorized data and a plurality of past grouping data, and wherein the past grouping data corresponds to the plurality of past vectorized data.

4. The method as claimed in claim 1, wherein the first machine learning and the second machine learning are one of a group consisting of a supervised learning, a semi-supervised learning, a reinforcement learning, an unsupervised learning, a self-supervised learning, a heuristic algorithms, and a combination thereof.

5. The method as claimed in claim 1, wherein the path data are one of a group consisting of a website trigger event, a website click event, a website operation behavior, a website stay time, and a combination thereof.

6. The method as claimed in claim 1, wherein the data vectorization operation converts one-dimensional data into one of a two-dimensional vector matrix, a three-dimensional vector matrix, or a multi-dimensional vector matrix.

7. The method as claimed in claim 1, wherein, in the step of retrieving path data of the network users and the step of vectorizing the path data, the server first transmits the result of the first machine learning to the client device so that the client device converts the path data into the vectorized data, and then transmits the vectorized data to the server.

8. A system for behavior vectorization of information de-identification, comprising:
a server having a data processing module, a data storage module, a vectorization module, and a grouping/classifying module which establish an information link with the server, respectively, the data processing module being provided for running the server, the data storage module being provided for storing data received and calculated by the server;
a data provider device establishing an information link with the server, the data provider device providing a path vector learning data and a vector grouping learning data to the server;
a client device establishing an information link with the server, the server retrieving a path data of the client device; wherein the vectorization module uses the path vector learning data as past data for performing a first machine learning, and wherein, after the first machine learning training is completed, a data vectorization action can be performed on the path data, and the path data can be converted into a vectorized data; and
wherein the grouping/classifying module uses the vector grouping learning data as past data for performing a second machine learning, and wherein, after the second machine learning training is completed, a grouping action can be performed on the vectorized data, and a grouping result is given to the vectorized data, and finally the grouping result is stored in the data storage module.

9. The system as claimed in claim 8, wherein wherein the path vector learning data include a plurality of past path data and a plurality of past vectorized data, and wherein the past vectorized data are one of a website trigger event, a website click event, a website operation behavior, a website stay time of the past path data, or a combination thereof.

10. The system as claimed in claim 9, wherein the vector grouping learning data include a plurality of the past vectorized data and a plurality of past grouping data, and wherein the past grouping data corresponds to the plurality of past vectorized data.

11. The system as claimed in claim 8, wherein the first machine learning and the second machine learning are one of a group consisting of a supervised learning, a semi-supervised learning, a reinforcement learning, an unsupervised learning, a self-supervised learning, a heuristic algorithms, and a combination thereof.

12. The system as claimed in claim 8, wherein the path data are one of a group consisting of a website trigger event, a website click event, a website operation behavior, a website stay time, and a combination thereof.

13. The system as claimed in claim 8, wherein the data vectorization operation converts one-dimensional data into one of a two-dimensional vector matrix, a three-dimensional vector matrix, or a multi-dimensional vector matrix.

14. The system as claimed in claim 8, wherein the server further establishes an information link with at least one edge server, and wherein the edge server assists the server and improves the computing function of the server with an edge computing function.
